(19) United States
(12) Patent Application Publication
(10) Pub. No.: US 2024/0419516 A1
(43) Pub. Date: Dec. 19, 2024

(54) PARALLEL EXECUTION OF SELF-ATTENTION-BASED AI MODELS

(71) Applicant: Etched.ai, Inc., Menlo Park, CA (US)

(72) Inventors: Gavin UBERTI, Kirkland, WA (US); Christopher ZHU, West Roxbury, MA (US)

(21) Appl. No.: 18/210,364

(22) Filed: Jun. 15, 2023

(51) Int. Cl. G06F 9/54; G06F 15/80

(52) U.S. Cl. CPC G06F 9/544; G06F 15/8046

(57) ABSTRACT

Embodiments herein describe an artificial intelligence (AI) hardware platform that includes at least one integrated circuit (IC) with a systolic array and a self-attention circuit. In one example, the systolic array performs operations in a layer of an AI model that do not use data from previous tokens or data sequences processed by the IC, while the self-attention circuit performs operations in the layer of the AI model that do use data from previous tokens or data sequences processed by the IC.

### TECHNICAL FIELD

Embodiments presented in this disclosure generally relate to parallel execution of an artificial intelligence (AI) model using an application specific integrated circuit (ASIC).

### BACKGROUND

Systolic arrays are hardware structures built for fast and efficient operation of algorithms that typically perform the same task with different data at different times. In some examples, a systolic array includes a homogeneous network of data processing units (DPUs) which each accumulate a partial result using data received from both upstream directions. Systolic arrays are often hard-wired for specific operations, such as performing massively parallel integration, convolution, correlation, matrix multiplication or data sorting tasks. Systolic arrays can also be used for dynamic programming algorithms which are often used in DNA and protein sequence analysis.

For many AI applications (e.g., transformer models), matrix multiplications dominate the operations that must be performed in hardware. Often, the matrix multiplications can be performed very efficiently by systolic arrays. In one example, the systolic arrays include a grid of DPUs which each perform a multiply-accumulate operation (MAC) every clock cycle. However, some operations in AI models cannot be performed efficiently using very large systolic arrays.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a systolic array, according to one embodiment.

FIG. 2 illustrates an integrated circuit with a systolic array and a self-attention circuit, according to one embodiment.

FIG. 3 illustrates an AI model, according to one embodiment.

FIGS. 4-6 illustrate parallel execution schemes of an AI model using the integrated circuit in FIG. 2, according to one embodiment.

FIG. 7 illustrates pipelining a combined systolic array, according to one embodiment.

FIG. 8 illustrates a package with a combined systolic array formed using a plurality of integrated circuits, according to one embodiment.

FIG. 9 is a flowchart for operating an IC with a systolic array and a self-attention circuit, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### SUMMARY

One embodiment presented in this disclosure is an integrated circuit that includes a systolic array configured to perform a first operation in a layer of an artificial intelligence (AI) model that does not use data from previous data sequences and a self-attention circuit configured to perform a second operation in the layer of the AI model that does use data from previous data sequences.

Another embodiment disclosed herein is a method that includes performing, using a systolic array in an IC, a first operation in a layer of an artificial intelligence (AI) model that does not use data from previous data sequences and performing, using a self-attention circuit in the IC, a second operation in the layer of the AI model that does use data from previous data sequences.

Another embodiment disclosed herein is a packet that includes a first memory device configured to store weights for an AI model, a second memory device configured to store data associated with a self-attention operation, and an IC. The IC includes a systolic array coupled to the first memory device and configured to perform a first operation in a layer of the AI model and a self-attention circuit coupled to the first memory device and configured to perform the self-attention operation in the layer of the AI model.

### DETAILED DESCRIPTION

Embodiments herein describe an AI hardware platform that includes at least one integrated circuit (IC) with a systolic array and a self-attention circuit. A systolic array is well suited for high-throughput matrix multiplication due to how well it scales. Rather than a general-purpose ALU (arithmetic logic unit) which may require several load/store sequences to compute a single matrix product, a systolic array can load all values at once and perform a matrix product with no idle clock cycles for waiting to store intermediate values in registers to memory.

Large systolic arrays are also efficient with respect to input/output bandwidth. For example, an N×N systolic array computes 2N\hat{ }2 FLOPs per clock cycle, while only requiring 2N input values per clock cycle. Many AI accelerators have adopted a systolic array architecture for computational efficiency and density, but there are some operations in AI models that are not well suited for large systolic arrays. For example, some attention operations use data from previous tokens, which can require large amounts of memory. Moreover, systolic arrays that are large in both dimensions cannot process these attention operations. However, systolic arrays that are large in both directions are very efficient at operating other operations such as multi-layer perceptron (MLP) operations.

The embodiments herein describe an IC that includes a systolic array that performs layer operations that do not use data from previous tokens and a self-attention circuit that performs layer operations that do use data from previous tokens. The systolic array and the self-attention circuit can be executed in parallel to improve throughput. For example, if the operations in the layers in the AI model are executed in sequence, the systolic array can execute layer operations for a first data sequence (e.g., a first token) while the self-attention circuit can execute an attention operation for a second, independent data sequence (e.g., a second token). Thus, the IC can process two independent tokens in parallel. If the layers in the AI model are not executed in sequence, then the systolic array can execute layer operations for a data sequence or a token while the self-attention circuit executes an attention operation for the same data sequence or token. The IC (along with potentially other ICs) can be formed in a package that interfaces with a host computer to serve as an AI accelerator.

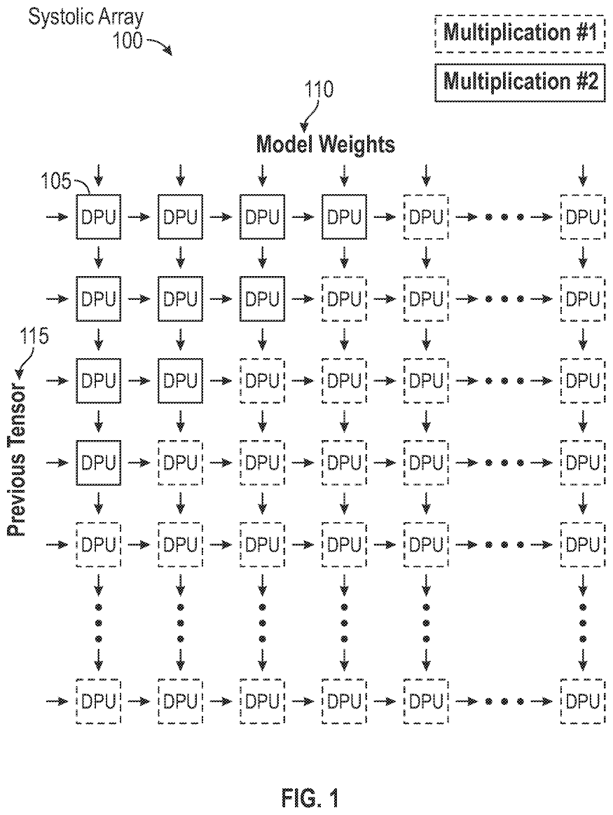

FIG. 1 illustrates a systolic array 100, according to one embodiment. In this example, the systolic array 100 includes a grid of DPUs 105 arranged in rows and columns. In this embodiment, the DPUs 105 perform a MAC operation, but are not limited to such.

The arrows in FIG. 1 illustrate the flow of data between the DPUs 105. Further, FIG. 1 illustrates using the systolic array 100 for matrix multiplication in running an AI model where the DPUs in the leftmost column receive a tensor 115, which can be a previous tensor 115 calculated by the systolic array 100. The topmost row of DPUs 105 receive AI model weights 110, which may be constants. Except for the leftmost column and the topmost row, the rest of the DPUs 105 receive an input from two of its neighbors (e.g., the left DPU and the top DPU).

After performing the MAC operation using the inputs, the DPU 105 passes those same inputs to its rightmost neighboring DPU 105 and the DPU 105 located beneath it. That is, in one embodiment, the weight and tensor data may pass between the rows and columns without being changed by the DPUs 105. In this manner, the data from the previous tensor 115 (e.g., the previous layer) flows from left to right while the model weights 110 flow from top to bottom.

In one embodiment, each DPU 105 performs an operation to generate partial results each clock cycle. That is, the DPU 105 can receive two new inputs and generate a new partial result each clock cycle. In one embodiment, each of the DPUs 105 add this result to an internal accumulator. Once the DPU has seen the entire tensor and weight values, the value stored in its accumulator is output as the computed answer.

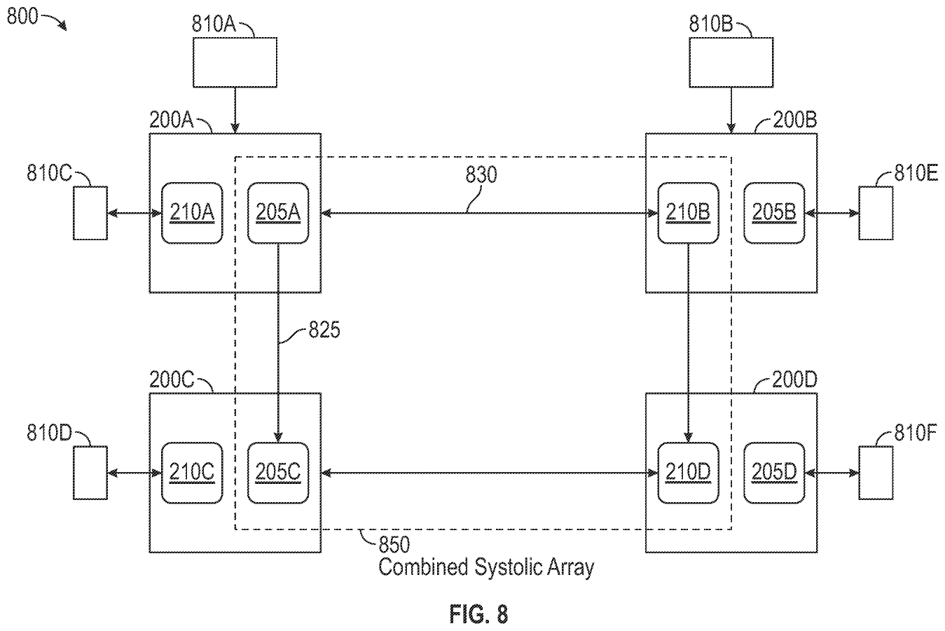

FIG. 1 also illustrates that the systolic array 100 can perform two different computations in parallel. That is, the DPUs 105 with hashing illustrate performing a first computation while the DPUs 105 without hashing perform a second computation. For example, the hashed DPUs 105 can perform a matrix multiplication corresponding to a first weight matrix while the non-hashed DPUs 105 can perform a matrix multiplication corresponding to a second weight matrix. In this manner, the systolic array 100 can perform different operations for a single layer in an AI model, or perform operations for different layers in the AI model, simultaneously. Furthermore, the DPUs 105 in the systolic array 100 can be distributed across multiple chips (ICs), which is discussed in more detail in FIG. 8.

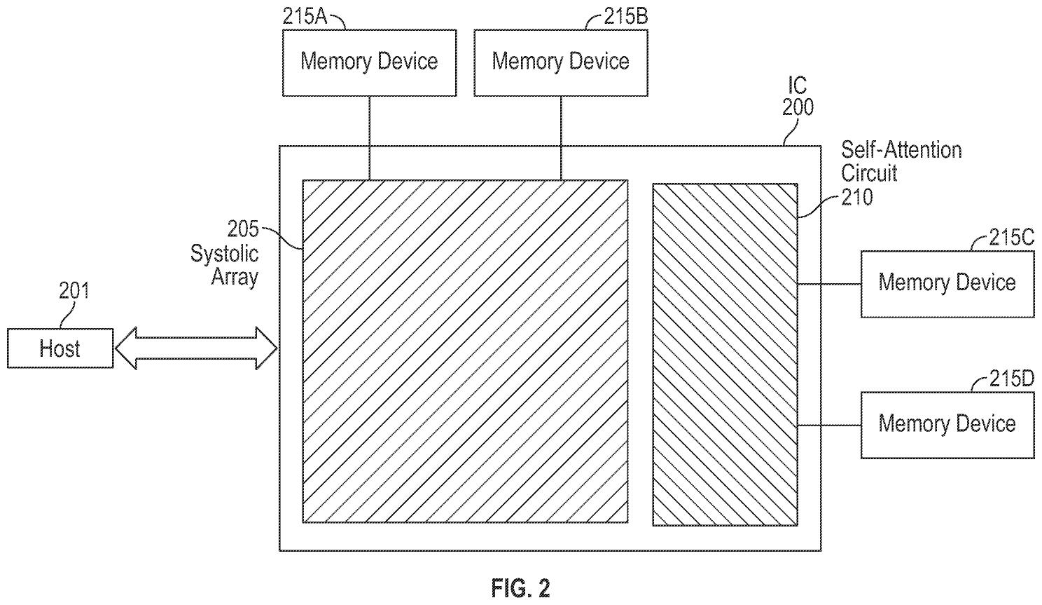

FIG. 2 illustrates an IC 200 with a systolic array 205 and a self-attention circuit 210, according to one embodiment. In this example, the IC 200 is coupled to a host 201 which can be a computing device (e.g., a server) or multiple computing devices. For example, the system may be deployed in a cloud computing data center with multiple hosts 201 (e.g., multiple computing devices) and multiple instances of the IC 200. In one embodiment, the host 201 and the IC 200 are disposed in the same form factor, but this is not a requirement.

Although not shown, the host 201 can include multiple processors (e.g., central processing units (CPUs) and memory. For example, the host 201 may execute an operating system that communicates with the IC 200 using the PCle connections. In one embodiment, the IC 200 is part of an accelerator such as a machine learning (ML)/AI accelerator. In one embodiment, the host 201 executes a software program that offloads AI/ML tasks to the IC 200 and receives the results from executing those tasks on the systolic array 205 and the self-attention circuit 210. In one embodiment, the host 201 can communicate with (e.g., offload task to) multiple, different AI accelerators which may be optimized for different AI models.

The host 201 can use any other suitable interconnect to transmit data to, and receive data from, the systolic array 205. In one example, the host 201 transmits data to a leftmost column of the systolic array 205 in the IC 200 to start a task for an application (e.g., an AI application) executing on the host 201. When the IC 200 is used as an AI accelerator for a language model, an application on the host 201 can submit an embedding vector corresponding to a piece of data (e.g., a group of characters, an embedding of a part of an image, or metadata) to the leftmost column of the systolic array 205. While the connections between the host 201 and the IC 200 can be used to load data into the systolic array 205, in one embodiment, the systolic array 205 does not take instructions at runtime, and only executes instructions in a preset loop.

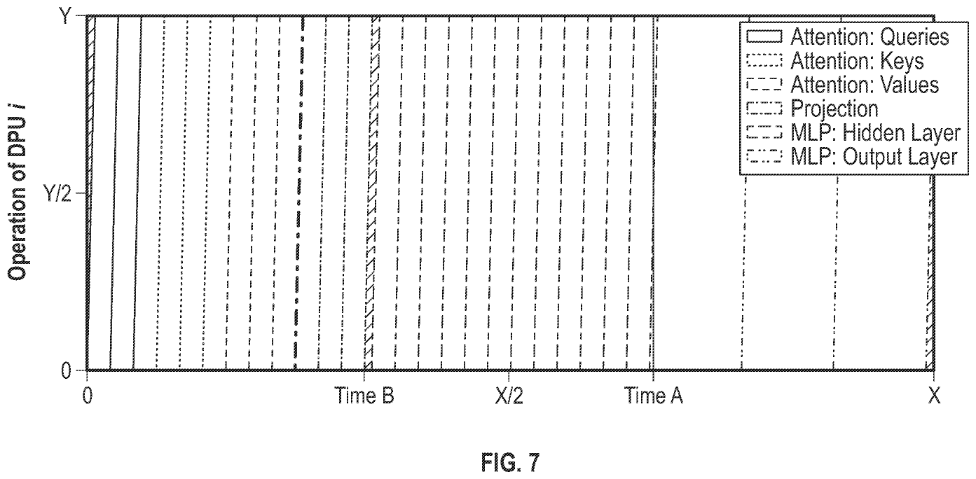

In one embodiment, the systolic array 205 is arranged like the systolic array 100 in FIG. 1 with rows and columns of DPUs. As such, the systolic array 205 can perform different operations for a single layer in an AI model, or perform operations for different layers in the AI model, simultaneously. This is discussed in more detail in FIG. 7.

In this example, the systolic array 205 is coupled to two memory devices-memory device 215A and 215B. In one embodiment, the memory devices 215 are High Bandwidth Memories (HBMs), but this is not a requirement. When used in an AI accelerator application, the memory devices 215A and 215B can store the weights for the AI model being used at runtime. The weights can be provided by the memory devices 215A and 215B to a top row of DPUs in the systolic array 205 where the weights are passed down through the rows of the systolic array 205. In one embodiment, the weights are constant when executing the systolic array 205. Nonetheless, although not shown, the system may include additional connections between the memory devices 215A and 215B and the host 201 so that an application on the host 201 can update the data (e.g., weights) stored in the memory devices 215A and 215B. Although FIG. 2 illustrates connecting two memory devices to the systolic array 205, one, three, four, etc. memory devices can be connected to the array 205.

The self-attention circuit 210 may be specialized circuitry to perform accelerator functions that are not efficiently performed by the systolic array 205. As a non-limiting example, for AI accelerators, self-attention operations use data computed from previous tokens, which means such data should be saved. Most of the parts of a transformer AI model do not use data from previous tokens (i.e., previous data sequences), and thus, can be calculated efficiently using the systolic array 205 which may consider each token in isolation from the other tokens being computed on. However, for operations that do use previous data computed from previous tokens, these operations can be delegated to the self-attention circuit 210. For example, a self-attention operation may require each row of a token to be multiplied by a different matrix where the different matrix is determined by data computed from previous tokens.

The self-attention circuit 210 is not limited to any particular type of circuit. Indeed, the function of the self-attention circuit 210 may change depending on the type of AI model being executed on the accelerator device. In one embodiment, the self-attention circuit 210 could be a separate systolic array (which has access to its own memory devices 215C and 215D), or could be a different type of processing element (e.g., a micro-processor, a controller, an arithmetic-logic unit (ALU), and the like).

As shown, the self-attention circuit 210 is coupled to the memory devices 215C and 215D (e.g., one or more HBMs). In other examples, the self-attention circuit 210 can be coupled to as many memory devices 215 as needed to complete the specific attention operation, or is permitted by packaging techniques. Because there are many different types of self-attention algorithms, each with their own memory capacity and bandwidth requirements, attaching the self-attention circuit 210 to as many memory devices 215 as possible can enable the accelerator device to support a greater number of such algorithms. For example, the self-attention circuit 210 could be coupled to memory devices disposed on multiple sides of the IC 200.

In one embodiment, the memory devices 215 are connected to the ICs 200 through a substrate, such as an interposer. Alternatively, the memory devices 215 can be stacked directly on the IC 200. For example, HBMs are themselves a stack of DRAM dies with an optional base die. The DRAM dies in the HBMs can be interconnected by through-silicon vias (TSVs) and microbumps. The HBMs can be disposed on the IC 200 directly and connect to the IC 200 using microbumps.

An HBM3 module is composed of 16 different channels that can operate completely independently. In one embodiment, of portion of those channels are dedicated for storing weights used by the systolic array 205 while other channels are used for some other purpose, such as memory for the self-attention circuit 210.

Further, in some embodiments, the memory devices 215A and 215B for the systolic array 205 may not be needed. Instead, the host 201 can provide the input data and weight data for both the X direction (e.g., by providing data to the leftmost column of the systolic array 205) and the Y direction (e.g., by providing weight data to the topmost row of the systolic array 205) using, e.g., the PCIe connections.

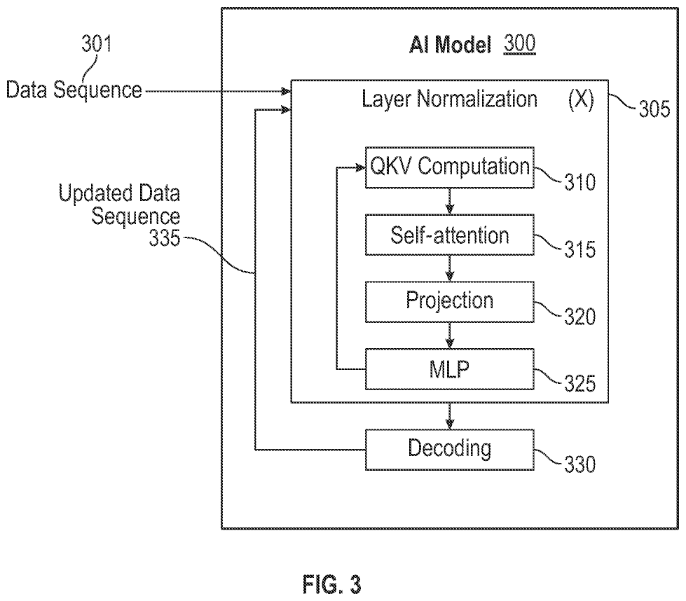

FIG. 3 illustrates an AI model 300, according to one embodiment. In this example, the AI model 300 is a transformer model such as a large language model or a transformer decoder. However, the embodiments herein are not limited to such and can be used with any AI model that includes layer operations that can be parallelized using the IC 200 in FIG. 2.

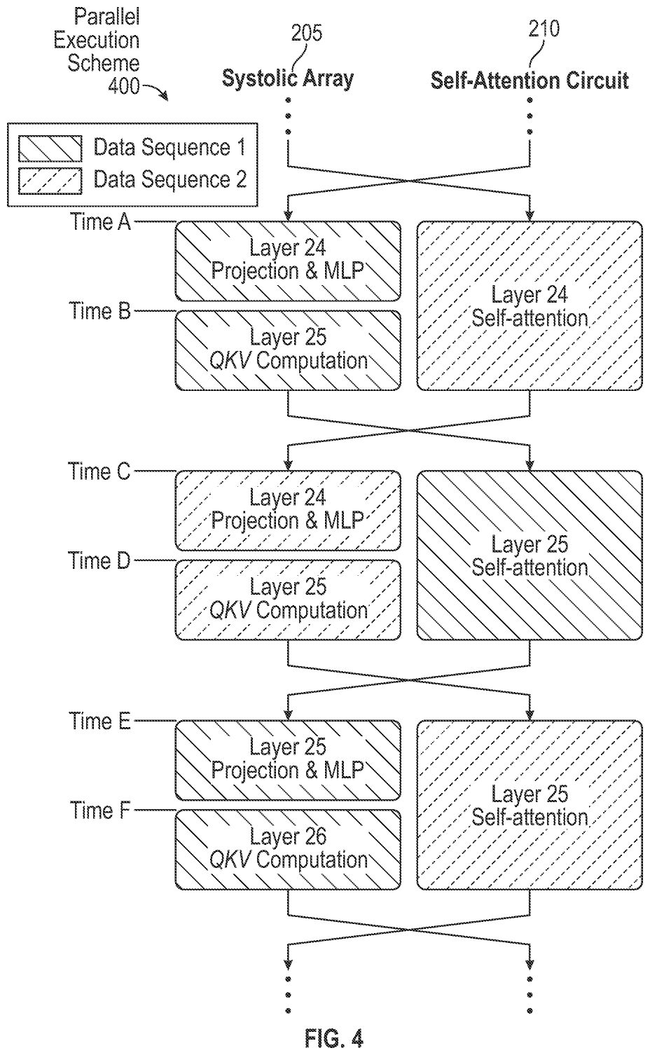

The bulk of the AI model 300 is the layer normalization 305 which includes X number of transformer decoder layers. For example, the X number of layers can determine the number of times the AI model 300 repeats QKV computation 310, self-attention 315, projection 320, and multi-layer perceptron (MLP) 325 for a particular data sequence 301 (e.g., a token or an embedded vector). The execution of the AI model 300 is discussed in more detail in FIGS. 4-6 below. In one embodiment, the architecture of each transformer decoder layer is identical, but their weights are different.

The layer normalization 305 operations can improve training speed and stabilize parts of the network (i.e. prevent outlier values from exerting too much influence). In one embodiment, each layer normalization block takes a row vector and applies an affine transformation so that it has mean 0 and standard deviation 1. In one embodiment, the layer normalizations 305 have a second affine transformation attached to the end, with tunable scalar parameters (which are different for each invocation of layer normalization). In one embodiment, layer normalization 305 is performed at the beginning of each transformer layer, once more in the middle of the transformer layer, and one last time after the final transformer decoder layer. That is, there can be two (or more) layer normalizations per layer block.

In one embodiment, the layer normalization 305 outputs a row vector which is copied X number of times and provided to X different heads (e.g., X different attention heads). In this example, the QKV computation 310 calculates three weight matrices—i.e., queries (Q), keys (K), and values (V)—for each head. Notably, no copying has to occur in the hardware since the different QKV computations for each head can be implemented as a single large matrix multiplication that generates the Q, K, and V matrixes in parallel. This can also include calculated biases for these matrices (e.g., QKV biases).

Self-attention 315 includes operations that use data from previous data sequences or tokens, but may also include operations that do not use data from previous data sequences. For example, self-attention 315 operations may require each row to be multiplied by a different matrix where the other matrix is determined by data computed from previous tokens. Example self-attention 315 operations that use data from previous data sequences can include Q×K^{T} scores and ×V scores, where T is a matrix transpose.

After concatenating the results from the heads, a row vector can be multiplied with a projection matrix as part of projection 320. Projection 320 can include multiplying each head by weights and adding biases.

In this embodiment, the MLP 325 performs non-linear transformations on the the output of the projection computation 320 rather than the original embedded input. In one embodiment, after calculating the results of the heads, the AI model 300 generates a two-layer perceptron which has a hidden layer and an output later. In one embodiment, a Gaussian Error Linear Unit (GeLU) activation function can be used in the hidden layer, but no activation is used for the output layer.

In one embodiment, the output vector of the MLP 325 operations is a vector that is then fed into the next one of the X transformer decoder layers (e.g., returns to perform the QKV computation 310 for the next layer). That is, the operations for QKV computation 310, self-attention 315, projection 320, and MLP 325 repeat for each of the transformer decoder layers (i.e., X number of times) for each data sequence 301 or token.

After the data sequence 301 passes through all X of the transformer decoder layers, it is decoded during decoding 330. Various different types of decoding 330 can be used to generate an updated data sequence 335, such as greedy search, beam search, constrained beam search, and the like. The embodiments herein are not limited to any particular type of decoding 330. Once the updated vector or token is identified, this updated data sequence 335 can then be sent back to layer normalization 305 where it passes through the X number of transformer decoder layers, which includes QKV computation 310, self-attention 315, projection 320, and MLP 325, as discussed above. In this manner, the AI model 300 can identify sequential vectors or tokens (e.g., words) based on a particular input. The resulting tokens (which may be letters or complete words) from each iteration of the AI model 300 can then be concatenated to provide a response or “answer” to the input.

FIGS. 4-6 illustrate parallel execution schemes of an AI model using the integrated circuit in FIG. 2, according to one embodiment. For clarity, the parallel execution schemes in FIGS. 4-6 are discussed using the AI model 300 in FIG. 3. However, as discussed above, the embodiments herein are not limited to such and can be used with any AI model that includes self-attention operations that use data from previous tokens.

FIG. 4 illustrates a parallel execution scheme 400 that shows the operations performed in the systolic array 205 and the self-attention circuit 210 in the IC 200 over a period of time. In this case, the array 205 and self-attention circuit 210 process two, independent data sequences in parallel (i.e., Data Sequence 1 and Data Sequence 2). These data sequences may correspond to two different inputs or queries to the AI model. For example, Data Sequence 1 may correspond to a first user submitting a question to the AI model while Data Sequence 2 corresponds to a second user submitting a different question to the AI model. FIG. 4 illustrates that the IC 200 can process data sequences corresponding to these two independent inputs or queries in parallel. Note that FIGS. 4, 5, and 6 are not necessarily drawn to scale time-wise.

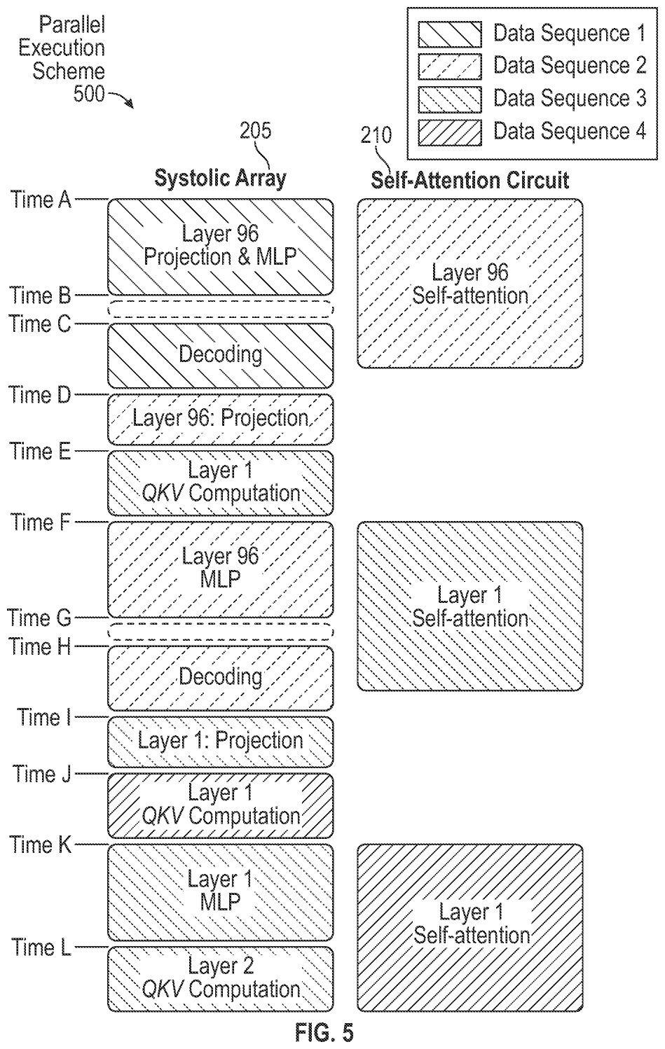

As mentioned above in FIG. 3, the AI model can have X number of transformer decoder layers. In the examples that follow it is assumed there are 96 decoder layers. Also, it is assumed that the operations in the AI model 300 are performed sequentially. First layer normalization is performed which then kicks off the 96 decoder layers which includes performing the QKV computation 310, then self-attention 315, then projection 320, and then MLP 325 (and in some embodiments another layer normalization before the MLP computation 325). That is, in this example, for each data sequence, QKV computation 310, self-attention 315, projection 320, and MLP 325 repeat 96 times. Once the 96 transformer decoder layers are complete, decoding is then performed (which is very different operation than the transformer decoder layers) to generate a new (or updated) data sequence. Decoding is discussed in more detail in FIG. 5.

At Time A in FIG. 4, both Data Sequence 1 and Data Sequence 2 are in Layer 24 of the 96 transformer decoder layers. That is, the array 205 and the self-attention circuit 210 have already calculated Layers 1-23 for these data sequences. Specifically, at Time A, the systolic array 205 is currently performing the Projection and MLP operations for Data Sequence 1. Referring to FIG. 3, this means that the QKV computation and the self-attention operations for Layer 24 have already been completed (which is not shown in FIG. 4).

Referring to Data Sequence 2, at Time A, the self-attention circuit 210 is currently performing the self-attention operations of Layer 24. This means that the QKV computation for Layer 24 has already been completed by the systolic array 205 (which is not shown in FIG. 4).

At Time B, the systolic array 205 has completed performing the Projection and MLP operations for Layer 24 of Data Sequence 1, which completes Layer 24 for this data sequence. Thus, at Time B the systolic array 205 begins to perform the QKV computations for Layer 25 of Data Sequence 1. In parallel, the self-attention circuit 210 is still performing the self-attention operations for Data Sequence 2.

Notably, in this implementation the self-attention operations for Data Sequence 2 finish at approximately the same time the systolic array 205 finishes the QKV computation for Data Sequence 1. That way, at Time C, the systolic array 205 can begin performing the projection and MLP operations for Layer 24 of Data Sequence 2 and the self-attention circuit 210 can begin performing the self-attention operation for Layer 25 of Data Sequence 1 with little or no idle time. That is, because the systolic array 205 uses the results of the self-attention operations to perform the projection and MLP operations, the systolic array 205 waits until the self-attention circuit 210 has finished these operations. Similarly, because the self-attention circuit 210 uses the results of the QKV computation to perform the self-attention operations, the self-attention circuit 210 waits until the systolic array 205 has finished these operations. Thus, FIG. 4 illustrates at Time C the systolic array 205 and the self-attention circuit 210 swapping the data sequences they are working on.

To enable this swap with little to no idle time, the size or the rate of computations of the systolic array 205 and the self-attention circuit 210 can be set (or configured) so that the time required by the systolic array 205 to complete the Projection, MLP and QKV computations is approximately the same as the time required by the self-attention circuit 210 to complete the self-attention operations. If these operations complete at near the same time, this means at Time C the systolic array 205 is ready to begin performing the projection and MLP operations for Data Sequence 2 and the self-attention circuit 210 is ready to begin performing the self-attention operations for Data Sequence 1. However, this performance matching of the systolic array 205 and the self-attention circuit 210 is optional.

At Time D, the systolic array 205 completes the projection and MLP operations for Layer 24 of Data Sequence 2, thereby completing Layer 24. The systolic array 205 then starts Layer 25 of Data Sequence 2 by performing the QKV computation. In the meantime, the self-attention circuit 210 continues to perform the self-attention operations for Layer 25 of Data Sequence 1.

Once the self-attention circuit 210 competes the self-attention operations for Layer 25 and the systolic array 205 is free, at Time E, the systolic array 205 performs the projection and MLP operations for Layer 25 using the results from the self-attention operations. Similarly, at Time E, the self-attention circuit 210 can begin to perform the self-attention operations for Layer 25 of Data Sequence 2 using the results from the QKV computation.

At Time F, the systolic array 205 completes the projection and MLP operations for Layer 25 of Data Sequence 1, thereby completing Layer 25. The systolic array 205 then starts Layer 26 of Data Sequence 2 by performing the QKV computation. In the meantime, the self-attention circuit 210 continues to perform the self-attention operations for Layer 25 of Data Sequence 2. In this manner, the systolic array 205 and the self-attention circuit 210 can swap performing operations for two different data sequences. That is, the systolic array 205 and the self-attention circuit 210 can execute the AI model for two different inputs or queries in parallel. Also, there can be parallelization within each data stream, so two data streams can represent many more queries.

FIG. 5 illustrates a parallel execution scheme 500 when reaching decoding in the AI model. As mentioned above, decoding is performed after the transformer decoder layers (96 layers in this example) for a particular data sequence have been performed. For example, it is assumed the previous 95 decoder layers for Data Sequence 1 and 2 have already been performed using the parallel execution scheme illustrated in FIG. 4.

At Time A, the systolic array 205 performs the projection and MLP operations for Layer 96 of Data Sequence 1. These are the last operations in each layer which means at Time B the systolic array 205 has completed Layer 96. However, before decoding can begin, in this example, the systolic array 205 needs the complete result of Layer 96 which may require data from every DPU in the systolic array 205. However, it may take time for the results from the DPUs in the far left column of the systolic array 205 to be passed to the far right column (i.e., the output) of the systolic array 205. Until that is complete, in this example, the decoding operation cannot begin. Thus, the time period between Time B and Time C indicates the length of time needed to “flush” the systolic array 205 which is generally dependent on the length of the row of the systolic array 205. Unfortunately, this is idle time where the systolic array 205 does not execute. However, the self-attention circuit 210 can still execute by performing the self-attention operations for Layer 96 of Data Sequence 2 (again assuming the QKV computation for Layer 96 has already been completed).

At Time C, the systolic array 205 begins to decode the data generated by the 96 layers. As discussed above in FIG. 3, the embodiments herein are not limited to any particular decoding technique (e.g., greedy search, beam search, constrained beam search, etc.). Like at Time B where the systolic array 205 requires data from every DPU in the systolic array 205, after performing decoding, the data from every DPU may be used to choose the next data sequence—i.e., Data Sequence 3. As such, the systolic array 205 may sit idle while waiting for the array 205 to again be flushed.

However, FIG. 5 illustrates a further pipelining feature where instead of simply waiting for the results of the DPUs to flush from the array 205, the array 205 can begin to perform the projection operations for Layer 96 of Data Sequence 2. Put differently, rather than having idle time such as the idle time between Time B and Time C, because the self-attention operations for Layer 96 have been completed, the systolic array 205 can begin performing the projection operations for Layer 96 while flushing the DPUs from performing the decoding operation for Data Sequence 1. As such, there is no (or very little) idle time when switching from the decoding operations for Data Sequence 1 and the projection operations for Layer 96 of Data Sequence 2 at Time D. Thus, the parallel execution scheme 500 can further mitigate idle time in the systolic array 205 after completing the decoding operations for a particular data sequence.

At Time E, the systolic array 205 begins performing the QKV computations for Layer 1 of Data Sequence 3. That is, the system uses the results from completing Data Sequence 1 to then select and input the Data Sequence 3 into the AI model.

At Time F, the systolic array 205 begins processing the MLP operations for Layer 96 of Data Sequence 2 while the self-attention circuit 210 performs the self-attention operations for Layer 1 of Data Sequence 3.

At Time G, the systolic array 205 finishes the last operations in each layer for Data Sequence 2. However, as discussed above, before decoding can begin the systolic array 205 needs the complete result of Layer 96 which may require data from every DPU in the systolic array 205—i.e., flushes the systolic array 205—before decoding can begin. Thus, the time period of Time G and Time H indicates the length of time needed to flush the systolic array 205 which may be the same as the time period between Time B and Time C. Unfortunately, this is idle time where the systolic array 205 does not execute but the self-attention circuit 210 can still execute the self-attention operations for Layer 1 of Data Sequence 3.

At Time H, the systolic array 205 begins the decoding operations for Data Sequence 2 using the results of performing the 96 layers. Again, before selecting the new data sequence for this query, the system may need to flush the systolic array 205. However, instead of remaining idle, at Time I the systolic array 205 can perform the projection operations for Layer 1 of Data Sequence 3 (since the self-attention operations were completed earlier). Thus, like during Time D, the parallel execution scheme 500 can avoid (or mitigate) idle time in the systolic array 205 after completed the decoding operations for a data sequence.

After flushing the systolic array 205, the system can use this information to then select the next data sequence—i.e., Data Sequence 4—for the query corresponding to Data Sequence 2. At Time J, the systolic array 205 begins the QKV computations for Layer 1 of Data Sequence 4. From Time K to Time L, the scheme 500 is the same as the scheme 400 in FIG. 4 where the systolic array 205 can perform the MLP operations and QKV computations for one data sequence (e.g., Data Sequence 3) while the self-attention circuit 210 performs the self-attention operations for an independent data sequence (e.g., Data Sequence 4). This pattern can repeat until again the system has completed the 96 layers for these data sequences and again performs the decoding operations as shown in the upper portion of the parallel execution scheme 500.

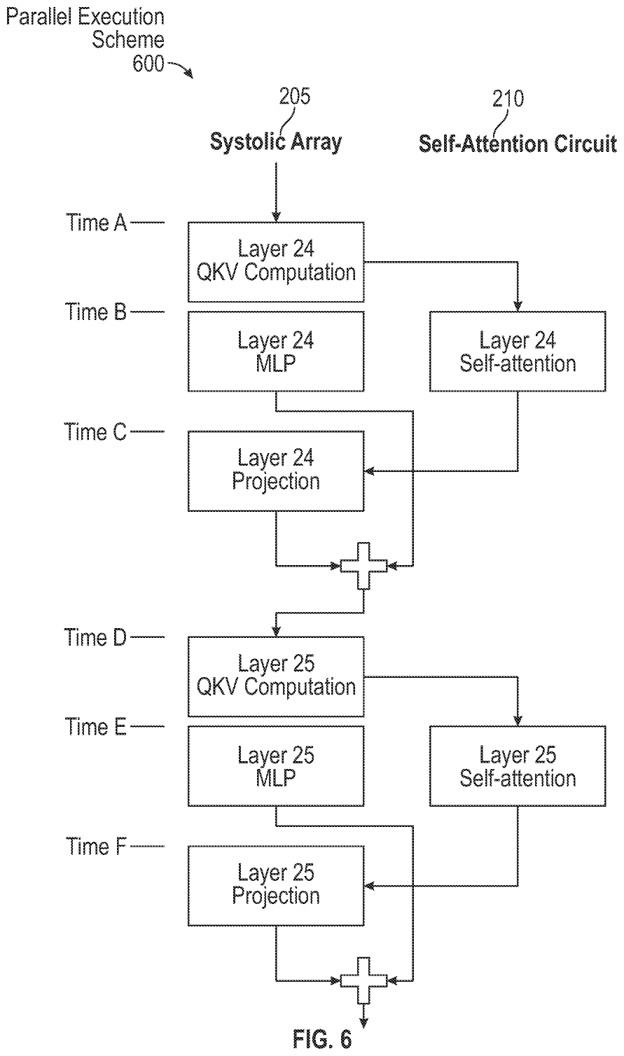

FIG. 6 illustrates a parallel execution scheme 600 that shows the operations performed in the systolic array 205 and the self-attention circuit 210 in the IC 200 over a period of time. Unlike in FIGS. 4 and 5 where the operations in a layer (e.g., QKV computations, self-attention, projection, and MLP) are performed in a specific order, in FIG. 6 it is assumed the MLP operations and the Self-Attention operations can be performed in parallel. As such, the array 205 and the self-attention circuit 210 can process at least some of the operations for the same data sequence in parallel.

As mentioned above in FIG. 3, the AI model can have X number of transformer decoder layers. In this example, there are 96 decoder layers.

At Time A in FIG. 6, the systolic array 205 begins to perform the QKV computations for layer 25. It is assumed that the array 205 and the self-attention circuit 210 have already calculated Layers 1-23 for this data sequence. The self-attention circuit 210 may use the QKV matrixes to perform self-attention for Layer 24, and thus, the self-attention circuit 210 is idle at Time A while it waits for the QKV computation to begin outputting the QKV matrixes.

At Time B, the systolic array 205 begins to perform the MLP operations for Layer 24 while the self-attention circuit 210 performs the self-attention operations for Layer 24. Both of these operations can use the output of the QKV computation, and thus, can be performed in parallel. Note, the parallel execution scheme 600 is different from the AI model 300 FIG. 3 since the QKV matrixes are input into the MLP rather than the output of the projection operations 320. Advantageously, in one embodiment, the self-attention operations can finish at approximately the same time the systolic array 205 finishes the MLP operations but this is not a requirement. For example, the MLP operations for Layer 24 may finish before the Self-attention operations. However, the projection operations for Layer 24 may be able to begin before the self-attention operations for Layer 24 is complete. As discussed in more detail in FIG. 7, the self-attention operations for layer 24 can output partial results which the projection operations for layer 24 can begin to process before the self-attention circuit 210 has completed all the self-attention operations for Layer 24.

At Time C, the systolic array 205 performs the projection operations of Layer 24 using the output of the self-attention operations. Once complete, the output of the projection operations and the MLP operations are summed to generate an output of Layer 24. After performing the summation, the systolic array 205 and the self-attention circuit 210 have completed the operations of Layer 24.

At Time D, the systolic array 205 begins to perform the QKV computations for layer 25. As explained above, the self-attention circuit 210 uses the QKV matrixes to perform self-attention for layer 25, and thus, the self-attention circuit 210 is idle at Time D while it waits for the QKV computation to begin outputting the QKV matrixes.

At Time E, the systolic array 205 begins to perform the MLP operations for Layer 25 while the self-attention circuit 210 performs the self-attention operations for Layer 25. Both of these operations can use the output of the QKV computation, and thus, can be performed in parallel. Advantageously, in one embodiment, the self-attention operations can finish at approximately the same time the systolic array 205 finishes the MLP operations, but again, this is not a requirement.

At Time F, the systolic array 205 performs the projection operations of Layer 25 using the output of the self-attention operations. Once complete, the output of the projection operations and the MLP operations are summed to generate an output of Layer 25. After performing the summation, the systolic array 205 and the self-attention circuit 210 have completed the operations of Layer 25.

FIG. 7 illustrates pipelining a combined systolic array, according to one embodiment, in the context of running a transformer AI model. Specifically, FIG. 7 illustrates the contents of one row of the combined systolic array while computing the output for one layer of the AI model (e.g., a transformer decoder layer discussed above). The X axis indicates the total number of clock cycles used to compute an output for one of the layers in the AI model while the Y axis indicates the number of DPUs in the row. As such, FIG. 7 illustrates what each DPU in the row of the systolic array is processing during each clock cycle.

The slanted, black lines indicate that the DPU produces an output during that cycle. The blank lines are slanted due to the Y number of cycles it takes data to propagate across each row of the systolic array, since data is transferred sequentially across consecutive DPUs each clock cycle. The bold dashed line indicates a swap between the two sequences currently being computed by the IC containing the systolic array. In this scenario, the IC contains both a systolic array and a self-attention circuit, and these two sections of the chip interchange data on a periodic basis. Each of the two sections of the chip computes values for its own sequence of data, handing off values to the other section to perform computations that it itself is not capable of performing (or may not be efficient at doing).

FIG. 7 also illustrates that the dimensions of the systolic array may not be large enough to perform one operation during a single pass through the array. In response, input tensors may be divided up and processed in multiple batches. For example, the output of an operation may be a square matrix, but the systolic array may be smaller in at least one dimension. As such, multiple batches may be used to calculate the desired output matrix for the operation. For example, to calculate the query values (e.g., perform the “Attention: queries” computation) used in the attention mechanism of transformer AI models, the data passes through the systolic array three times. For example, the input tensor for calculating the query values may be divided into three portions, where the portions are inputted into the systolic array in three batches. This is the same for performing the “Attention: keys”, “Attention: values”, and “Projection” operations, which also appear in the example of running a transformer AI model. Continuing this example, the hidden and output layers for MLP operations may also use multiple batches or passes to calculate the outputs.

To achieve 100% efficiency (or close to 100% efficiency), the inputs for the subsequent computation are fed into the systolic array before the previous computation completes. For example, at Time A, the leftmost DPU in the row (e.g., DPU 0) is performing the computation associated with the output layer of the MLP, while the rightmost DPU in the row (e.g., DPU Y) is still working on the previous computation, the MLP hidden layer. When switching from the hidden layer to the output layer of the MLP, post-processing work (e.g., residual addition, GeLU, etc.) may be performed. That is, post processing may be performed before the inputs are moved from the rightmost chips in the systolic array to be re-fed into the leftmost chips in the systolic array. To prevent a stall, this post-processing can be performed on the values that have already been generated (e.g., compute a GeLU for every value) and fed back into the input to start a new computation while the previous computation is still occurring. In this manner, when there is data dependency between different operations in a sequence, post-processing can still be performed and the data fed back to the inputs of the systolic array without causing a delay. This is also illustrated in the parallel executes schemes in FIGS. 4-6 above where the systolic array can switch between operations in a transformer decoder layer without a stall.

However, in some situations, a stall may occur (e.g., the stall at Times B-C and G-H in FIG. 5). For most post-processing operations such as scaling, biasing, residual connections, and GeLU, these operations can be performed before an entire row vector has been computed by the systolic array, as they are elementwise (broadcast) operations. This permits the accelerator to begin feeding the output layer of the MLP model before fully computing the hidden layer of the MLP. Decoding (and more specifically, layer normalization) may be different, however. Layer normalization may require scaling based on the mean and variance of the row vector, which cannot be known until the entire input row vector is known. This means the systolic array may stall during layer normalization of decoding. This is shown at Time B where the array stalls for the amount of clock cycles that equals the number of DPUs in the row (i.e., X number of clock cycles). The array may stall for some additional clock cycles to provide time to feed the mean and variance values to the input of the systolic array. In any case, the stalled time may be small relative to the computation time and still result in a 98% or greater utilization of the systolic array.

Moreover, there may be additional stall time (or idle time) at the beginning and the end of the layers as the values are being flushed (i.e., X number of clock cycles). These portions of the graph have the same hashing as at Time B.

FIG. 8 illustrates a package 800 with a combined systolic array formed using a plurality of ICs 200, according to one embodiment. FIG. 8 illustrates four ICs 200A-D which each includes a systolic array 205A-D and a self-attention circuit 210A-D which were described in FIG. 2. In this embodiment, the local systolic arrays 205 in the ICs 200 are combined to form a larger, combined systolic array 850. For example, from the perspective of the host, the systolic array 850 appears to be one large array, even though it is physically made up of smaller local systolic arrays 205 distributed on separate ICs 200. In one embodiment, the ICs 200 are all identical.

The local systolic arrays 205 can be interconnected using horizontal and vertical chip-to-chip connections 825 and 830. In one embodiment, the horizontal connections 830 are bidirectional which permits data to flow from left to right and from right to left, while the vertical connections 825 are unidirectional which permits data to flow only from top to bottom (not from bottom to top). The chip-to-chip connections 825 and 830 are not limited to any particular type of connection, so long as the connection permits the flow of data between the local systolic arrays 205 so that the DPUs can output data each clock cycle. In one embodiment, Universal Chiplet Interconnect Express (UCIe) can be used to form the chip-to-chip (or die-to-die) connections 825 and 830, which has a physical layer that supports up to 32 GT/s with 16 to 64 lanes.

Further, the top row of the ICs (i.e., IC 200A and 200B) can be connected to memory chips 810. While FIG. 8 illustrates connecting the ICs 200 in the top row to one memory chip 810, they can be connected to any number of memory chips 810.

As shown, the self-attention circuits 210 in each IC 200 is coupled to at least one local memory chip 810 (e.g., one or more HBMs). In other examples, the self-attention circuits 210 in each of the ICs 200 can be coupled to as many local memories 810 as needed to complete the specific operation, or is permitted by packaging techniques. Because there are many different types of self-attention algorithms, each with their own memory capacity and bandwidth requirements, attaching self-attention circuits 210 to as many local memory chips 810 as possible can enable the accelerator device to support a greater number of such algorithms.

For example, four local memory chips 810 could be disposed around each IC 200—e.g., two memory chips 810 on opposite sides, or one memory chip 810 disposed on each side. Further, in one embodiment, the ICs 200 may be attached to the same number of local memory chips 810. However, in other embodiments, the ICs 200 may be coupled to different number of local memory chips 810.

In one embodiment, the local systolic arrays 220 do not have access to some of the local memory chips 810, and the self-attention circuits do not have access to some of the local memory chips 810. For example, only the self-attention circuit 210A may be able to access the local memory chip 810C, while only the systolic array 205A can access the local memory chip 810A. However, in other examples, the local systolic arrays 220 and the self-attention circuits 210 can access every memory chip connected to the IC 200. For instance, instead of (or in addition to) using local SRAM on the IC 200A, the local systolic array 205A may use the memory chip 810C as scratchpad space when performing their operations.

In one embodiment, the self-attention circuits 210 in one IC 200 cannot directly communicate with the self-attention circuits 210 in another IC 200. For example, the self-attention circuits 210 in each IC 200 may operate independently of each other. Instead, the self-attention circuits 210 in each IC 615 may interface with the local systolic array 205 on the same IC 200 in order to pass data and results to the self-attention circuits 210 in other ICs 200. Alternatively, the self-attention circuits 210 in the ICs 200 may be interconnected to each other using the horizontal and vertical chip-to-chip connections 825, 830 in a same or similar way as the local systolic arrays 205 are interconnected to form the combined systolic array 850.

In one embodiment, the package 800 may include a silicon wafer interposer or conventional PCB substrate on which the ICs 200 are disposed in grid-like pattern. The chip-to-chip connections 825 and 830 may be formed in the interposer. However, in another embodiment, the ICs 200 may be formed in a stack, rather than being disposed side-by-side as shown in FIG. 8. For example, the systolic array 850 may include just one row of the ICs 200 where the ICs 200 are stacked on top of each other. Micro bumps or copper pillars can be used to form the chip-to-chip connections directly between the ICs 200 in the stack to form a combined systolic array 850 from the local systolic arrays 205 in each of the ICs 200.

In one embodiment, the bandwidth of the connection of the horizontal chip-to-chip connections 830 is different for data flowing from left to right relative to data flowing from right to left. In one example, the connections 830 may provide much higher data rates for data moving from left to right than the data rates for transferring data right to left. For example, the systolic array 850 may use the right to left bandwidth to return results generated by the ICs 200 in the rightmost column back to the inputs of the systolic array 850 at the ICs 200 in the leftmost column. As a non-limiting example, the left-to-right data paths in the horizontal connections 830 may support data streams of hundreds of GBs, while the right-to-left data paths in the horizontal connections 830 may support data streams of tens of GBs (or less). Furthermore, the left-to-right data paths in the horizontal connections 830 may have a fairly constant utilization while the right-to-left data paths may be bursty (e.g., used when the computation for a row vector has been completed and the resultant values are being fed back to the leftmost input column of ICs 200).

The size of the local systolic arrays 205 can vary. For example, the arrays 205 can have sizes of approximately 100-10000 rows and 100-10000 columns of DPUs. However, this can vary depending on the overall physical size of the ICs 200, the process node used to fabricate the ICs 200 (e.g., 7 nm, 10 nm, 14 nm, 22 nm, 32 nm, etc.) and the other circuitry in the ICs 200 beside the local systolic arrays 205—e.g., the size of the self-attention circuits 210.

The package 800 can include any number of the ICs 200, which can have any number of rows and columns. For example, the combined systolic array 850 may be formed from a single row of ICs 200, or from a single column of ICs 200. In that case, assuming each IC 200 has a local systolic array 205 of dimensions 100×100 (measured in terms of DPUs within the systolic arrays 205), a single row of four ICs 200 would form a 100×400 combined systolic array 850 while a single column of four ICs 200 would form a 400×100 combined systolic array 850. Different packages 800 may have different sizes of systolic arrays 850 depending on their applications (e.g., depending on the type of computation being performed). Moreover, the physical limitations of current packaging techniques and IC technology may limit the number of ICs 200 that can be disposed in the same package 800.

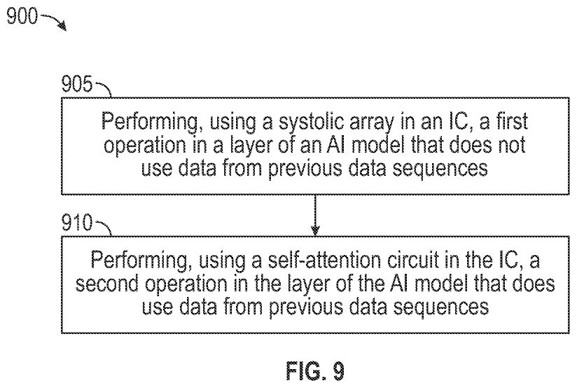

FIG. 9 is a flowchart of a method 900 for operating an IC with a systolic array and a self-attention circuit, according to one embodiment. In one embodiment, the method 900 can be used to execute an AI model using the IC 200 in FIG. 2.

At block 905, the systolic array in the IC performs a first operation in a layer of an AI model that does not use data from previous data sequences (or tokens). These operations may include QKV computations, projection operations, MLP operations, decoding operations, layer normalization operations, and the like. The types of operations that are performed using the systolic array may vary depending on the type of AI model (e.g., whether it is a transformer model or some other type of AI model).

At block 910, the self-attention circuit in the IC performs a second operation in the layer of the AI model that does use data from previous data sequences. These operations can include any operation where data from previous data sequences (or tokens) is used to calculate a result for the current data sequence being processed by the IC. For example, a self-attention operation may require each row of a token to be multiplied by a different matrix where the other matrix is determined by data computed from previous tokens.

As discussed above, the first operation in block 905 and the second operation in block 910 can be performed in parallel. For example, in FIG. 4 at Time B, the systolic array 205 performs QKV computations (e.g., a first operation) for Layer 25 of the Data Sequence 1 while the self-attention circuit 210 performs self-attention operations (e.g., a second operation) for Layer 24 of the Data Sequence 2. Thus, in this example, the first and second operations are performed in parallel, but on different layers of different data sequences. In contrast, at Time A, the systolic array 205 performs projection and MLP (e.g., a first operation) for Layer 24 of Data Sequence 1 while the self-attention circuit 210 performs self-attention operations (e.g., a second operation) for Layer 24 of the Data Sequence 2. Here, the first and second operations being performed in parallel are for the same layer but for different data sequences.

In contrast, in FIG. 6 at Time A, the systolic array 205 performs QKV computations (e.g., a first operation) for Layer 24 of a data sequence while the self-attention circuit 210 performs self-attention operations (e.g., a second operation) for Layer 24 of the same data sequence. Thus, in this example, the first and second operations are performed in parallel for the same layer and for the same data sequence.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An integrated circuit (IC), comprising:
a systolic array configured to perform a first operation in a layer of an artificial intelligence (AI) model that does not use data from previous data sequences; and
a self-attention circuit configured to perform a second operation in the layer of the AI model that does use data from previous data sequences.

2. The IC of claim 1, wherein, for a particular data sequence, the first operation must be performed before the second operation.

3. The IC of claim 2, wherein, during a first time period, the systolic array is configured to perform the first operation for a first data sequence in parallel with the self-attention circuit performing the second operation for a second data sequence.

4. The IC of claim 3, wherein, during a second time period following the first time period, the self-attention circuit is configured to perform the second operation for the first data sequence in parallel with the systolic array performing a third operation in the layer of the AI model for the second data sequence, wherein the third operation must be performed after the second operation.

5. The IC of claim 4, wherein the first and second data sequences correspond to different inputs or queries made to the AI model.

6. The IC of claim 3, wherein the AI model comprises performing X number of transformer decoder layers for each of the first and second data sequences, wherein, during the first time period, the first operation corresponds to a Y^{th} transformer decoder layer of the transformer decoder layers for the first data sequence while the second operation corresponds to a Y−1^{th} transformer decoder layer of the transformer decoder layers for the second data sequence.

7. The IC of claim 6, wherein the AI model comprise decoding operations performed after the X number of transformer decoder layers have been completed, wherein the systolic array is configured to:
perform decoding operations for the first data sequence during a second time period following the first time period;
perform a third operation in the layer of the AI model for the second data sequence during a third time period following the second time period; and
perform the first operation for a third data sequence during a fourth time period following the third time period, wherein the third data sequence is based on results of the decoding operations.

8. The IC of claim 7, wherein the third time period is sufficiently long to flush results from performing the decoding operations from every data processing unit (DPU) in the systolic array.

9. The IC of claim 1, wherein the first operation can be performed in parallel with the second operation, wherein, during a first time period, the systolic array is configured to perform the first operation for a first data sequence in parallel with the self-attention circuit performing the second operation for the first data sequence.

10. The IC of claim 1, wherein the second operation performed by the self-attention circuit comprises multiplying each row of a token by a different matrix which is based on data computed from previous tokens.

11. A method, comprising:
performing, using a systolic array in an IC, a first operation in a layer of an artificial intelligence (AI) model that does not use data from previous data sequences; and
performing, using a self-attention circuit in the IC, a second operation in the layer of the AI model that does use data from previous data sequences.

12. The method of claim 11, wherein, for a particular data sequence, the first operation must be performed before the second operation.

13. The method of claim 12, wherein, during a first time period, the first operation is performed for a first data sequence using the systolic array in parallel with the self-attention circuit performing the second operation for a second data sequence.

14. The method of claim 13, during a second time period following the first time period, the self-attention circuit performs the second operation for the first data sequence in parallel with the systolic array performing a third operation in the layer of the AI model for the second data sequence, wherein the third operation must be performed after the second operation for both the first and second data sequences.

15. The method of claim 13, wherein the AI model comprises performing X number of transformer decoder layers for each of the first and second data sequences, wherein, during the first time period, the first operation corresponds to a Y^{th} transformer decoder layer of the transformer decoder layers for the first data sequence while the second operation corresponds to a Y−1^{th} transformer decoder layer of the transformer decoder layers for the second data sequence.

16. The method of claim 15, wherein the AI model comprise decoding operations performed after the X number of transformer decoder layers have been completed, wherein the method comprises:
performing, using the systolic array, decoding operations for the first data sequence during a second time period following the first time period;
performing, using the systolic array, a third operation in the layer of the AI model for the second data sequence during a third time period following the second time period; and
performing, using the systolic array, the first operation for a third data sequence during a fourth time period following the third time period, wherein the third data sequence is based on results of the decoding operations.

17. The method of claim 16, wherein the third time period is sufficiently long to flush results from performing the decoding operations from every DPU in the systolic array.

18. A package, comprising:
a first memory device configured to store weights for an AI model;
a second memory device configured to store data associated with a self-attention operation; and
an IC comprising:
a systolic array coupled to the first memory device and configured to perform a first operation in a layer of the AI model; and
a self-attention circuit coupled to the first memory device and configured to perform the self-attention operation in the layer of the AI model.

19. The package of claim 18, wherein the first operation does not use data from previous tokens processed by the IC but the self-attention operations do use data from previous data sequences processed by the IC.

20. The package of claim 18, wherein, for a particular data sequence, the first operation must be performed before the self-attention operation, wherein, during a first time period, the systolic array is configured to perform the first operation for a first data sequence in parallel with the self-attention circuit performing the self-attention operation for a second data sequence.
